(19) United States
(12) Patent Application Publication
(10) Pub. No.: US 2010/0091193 A1
(43) Pub. Date: Apr. 15, 2010

(54) AMBILIGHT DISPLAYING ARRANGEMENT

(75) Inventors: Willem Franciscus Johannes Hoogenstraaten, Eindhoven (NL); Johannes Petrus Antonius Maria Van Asseldonk, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/521,785

(22) PCT Filed: Dec. 20, 2007
(86) PCT No.: PCT/IB2007/055243

§ 371 Date: Jun. 30, 2009

(30) Foreign Application Priority Data
Jan. 3, 2007 (EP) 07100047.5

(51) Int. Cl. H04N 9/74; H04N 5/66

(52) U.S. Cl. 348/578; 348/739; 348/E05.133; 348/E09.055

(57) ABSTRACT

Disclosed are embodiments of AmbiLight TV, a lighting or illumination system that has been introduced to enhance viewing experience. The system comprises one or two U-shaped light guides, the legs of which spatially correspond to three or four sides of the display screen. In one embodiment, the light sources illuminate a background surface behind the TV such as a wall. In another embodiment, the light sources are arranged around the display screen in substantially the same planar area, and radiate light to the front. In yet another embodiment, the light sources are arranged to directly or/and indirectly illuminate the dark area between the pixel area of the display screen and the front of the lighting or illumination system.

### FIELD OF THE INVENTION

In the recent past, the company Philips introduced AmbiLight TV, a television receiver provided with rear light sources to illuminate the wall behind the TV. By automatically adapting the color of the light to the contents of the video image, AmbiLight offered a more immersive viewing experience to the viewer. An initial version of AmbiLight TV provided illumination of the left and right side with one color per side. Later generations were fitted with top and bottom light sources, still with one color per side.

### BACKGROUND OF THE INVENTION

The AmbiLight solutions introduced by the company Philips in the recent past have enjoyed an enormous success around the world. However, due to the tremendous and increasing variety of viewer requirements, desires and demands, it is necessary to further develop the existing AmbiLight solutions and/or create new ones.

The present invention seeks to further satisfy the fastidious viewer.

### SUMMARY OF THE INVENTION

One limitation of the current AmbiLight solutions is that there is a dark area between the pixel area of the display screen and the front of the lighting or illumination system, e.g. between the pixel area of the display screen and the bezel or the diffuser of said lighting or illumination system. The panel rim of the display device not being illuminated could reduce to some extend the immersive viewing experience for the viewer.

Another limitation of the current AmbiLight solutions is that each side is considered to have an individual lighting or illumination system, either a light guide or a light source (LED) array. A full surround system will then comprise of 4 individual lighting or illumination systems with their own electrical and mechanical infrastructures adding up to the overall cost.

It may be seen as an object of the present invention to further enhance the viewing of video image(s) on the display screen. According to the present invention, this can be achieved by directly or/and indirectly illuminating the dark area between the pixel area of the display screen and the front of the lighting or illumination system (e.g. the pixel area of the display screen and the bezel or the diffuser), thus covering with illumination the area of the panel rim.

It may also be seen as an object of the invention to further simplify and economize the AmbiLight TV concept. According to the invention, this can be achieved by providing the display system with at least one U-shaped light guide, the legs of the light guide spatially corresponding to respective sides of the display screen. Herewith it is achieved that three sides of the display screen can be illuminated with only two light sources (preferably LEDs), one at each end of the U. This requires a very simple infrastructure for the overall system, thus reducing the costs tremendously. It is believed that the attractive AmbiLight TV feature will thus be made affordable in the lower TV, display and/or monitor segments.

In one possible embodiment, two U-shaped light guides are used in such a configuration that together they form a closed ellipse-like shape. In this case, a “full surround” (all sides of the display device or TV) AmbiLight TV system is achieved at reasonable costs. The four ends of the two U-shaped light guides are each driven by a light source, e.g. a LED. The LEDs are sitting back to back and may receive the same signal. The light sources can be arranged to illuminate the surface, e.g. the wall, behind the displaying arrangement or display device.

Alternatively or additionally, in another possible embodiment the light sources can be arranged to radiate light to the front of the displaying arrangement. This is referred to as AmbiLight with bezel illumination. It creates an aura closer around the screen and it is more visible in environments with brighter illumination. Besides that it makes AmbiLight possible for devices that are not in the proximity of a wall to reflect the light, like monitors.

Alternatively or additionally, it is also possible to have the light sources arranged to illuminate directly or/and indirectly the dark area between the pixel area of the display screen and the front of the lighting or illumination system which is being arranged wholly or partially around the displaying arrangement, thus completely or partially covering with illumination the area of the panel rim.

Alternatively or additionally, it is also possible to have the light sources arranged to further cooperate with the reflector or the diffuser or with both of them in order to achieve said direct or/and indirect illumination of the above-mentioned dark area. It is a matter of different constructions of the lighting or illumination system.

The main features of the present invention are described in the independent claims.

Additional features of the invention are presented in the dependent claims.

These and other objects, aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which:

FIG. 1 illustrates an initial version of AmbiLight TV providing illumination to the left and right side and with one color per side;

FIG. 2 illustrates a “full surround” AmbiLight TV system;

FIG. 3 shows a cross section of a displaying arrangement having a lighting or illumination system;

FIG. 4 shows a cross section of another displaying arrangement having a different lighting or illumination system;

FIG. 5 shows a lighting or illumination system using one U-shaped light guide;

FIG. 6 shows one example of a full surround lighting or illumination system using two U-shaped light guides driven by 4 light sources;

FIG. 7 shows another example of a full surround lighting or illumination system using two U-shaped light guides driven by 4 light sources;

FIG. 8 shows yet another example of a full surround lighting or illumination system using one O-shaped light guide driven by two back-to-back light sources;

FIGS. 9a and 9b show two different shapes of light guides that can be used in a lighting or illumination system;

FIG. 10 shows another example of a full surround lighting or illumination system using two of the light guides shown on FIG. 9b.

### DETAILED DESCRIPTION OF THE EMBODIMENTS

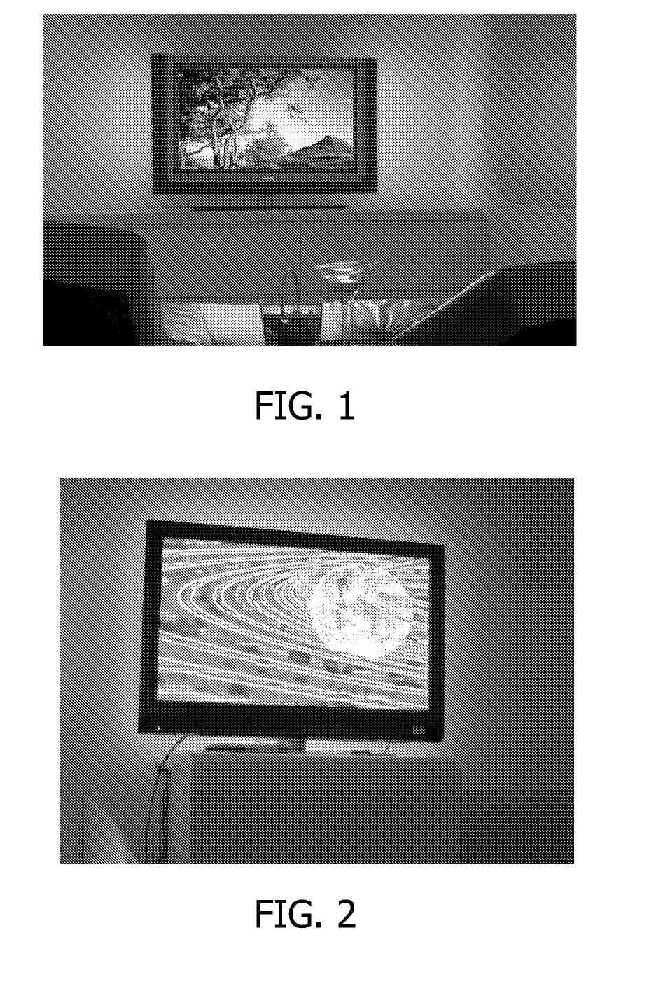

FIG. 1 shows an existing version of AmbiLight TV providing illumination to the left and right side.

A “full surround” AmbiLight TV system is shown in FIG. 2. In this case all sides of the displaying arrangement are surrounded by the lighting or illumination system.

The displaying arrangement can be any TV, monitor, display, screen or any other suitable arrangement on which image(s) can be displayed and/or projected.

The invention can be based on the principles of a linear light guide, e.g. a massive PMMA tube, with a pattern (e.g. a scattering pattern, etc.) on it to get light out of the light guide in a controlled manner. The principle of light guide is well known. A point light source transmits into a transparent material with a highly reflective (polished) surface. This material is either painted with a white pattern or mechanically indented to have light emitted in a controlled manner in a desired direction and with a desired beam shape.

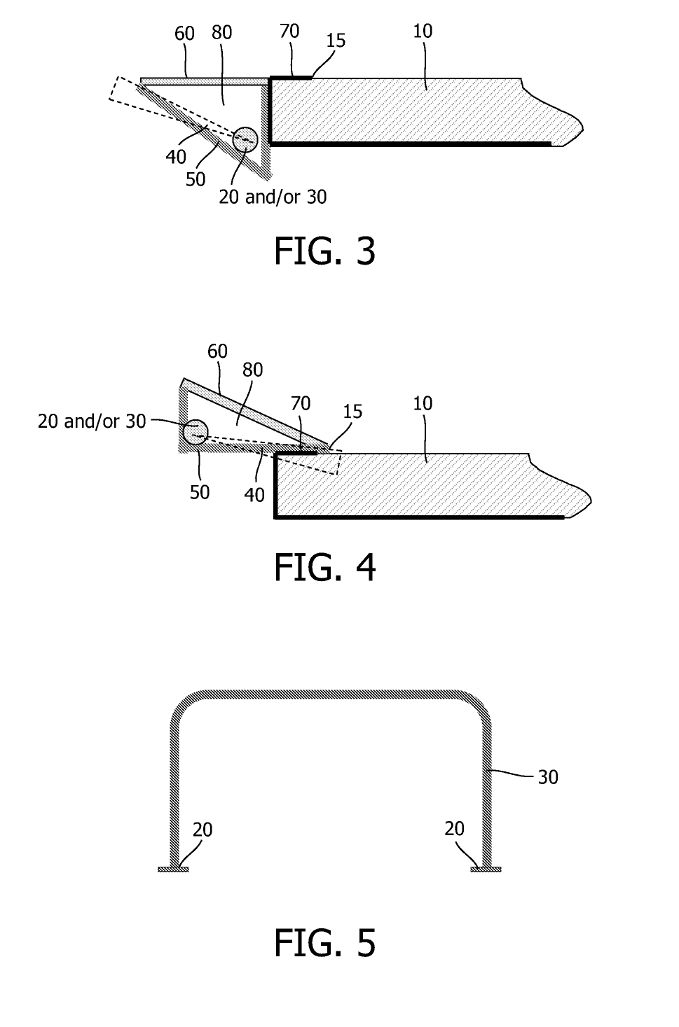

A display device with bezel illumination is shown in FIG. 3 comprising a screen 10 (front side up), being a LCD, plasma or any other panel, or any other image rendering surface, such as a projected image. Around the screen 10 a diffuser 60 and/or a reflector 50 can be arranged or placed forming a cavity 80. In that cavity 80 a light source 30 is mounted in the form of a light guide or an array of LEDs. The light 40 from the light source 30 hits the surfaces of the cavity 80 to ensure homogenous spreading of the light, before it leaves the transparent diffuser 60. The light source 30, preferably but not necessarily a light guide with a round cross section, has a pattern to beam the light 40 in such a way that the matt white reflector 50 is fully illuminated, without direct illumination of the transparent diffuser 60. FIGS. 3 and 4 show cross sections of two alternative embodiments.

The possible embodiment shown in FIG. 4 does not have the limitation of a dark area between the pixel area of the screen 10 and the front of the lighting or illumination system, e.g. the bezel. In this possible embodiment at least one light source, being a pure light source, e.g. LED, 20 and/or a light guide 30, is arranged to directly (or indirectly, e.g. via a further reflector) illuminate the dark area 70 between the pixel area of the display screen 10 and the front, e.g. the diffuser 60, of the lighting or illumination system, thus covering with illumination the area of the panel rim 70. In this embodiment the light source is arranged or placed around the display screen 10 and completely or partially in front of the planar area of the screen 10 in order to enable the light source to directly illuminate the panel rim 70.

It is also possible to have the reflector 50 comprising a window section (not shown) allowing the light from the light source(s) 20, 30 to be split into two in such a way that half or more of the light is being directed to the background of the display device and half or less of the light is being directed to the diffuser 60 thus illuminating the front of the bezel.

FIG. 5 shows a lighting or illumination system according to the invention using one U-shaped light guide 30. A multi-color LED light source 20 is provided at each end of the light guide 30. In this way three sides of the display device or arrangement can be illuminated with the help of only one light guide 30 and two light sources 20, thus tremendously simplifying the lighting or illumination system and reducing the costs.

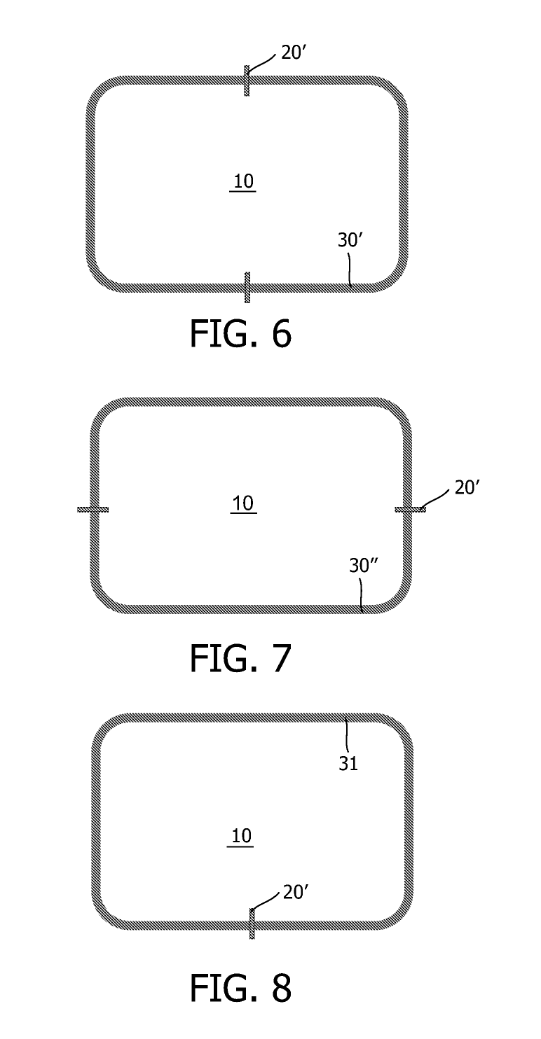

FIGS. 6 and 7 show two examples of a full surround lighting or illumination system using two U-shaped light guides 30′ (in FIG. 6), 30″ (in FIG. 7) driven by 4 light sources 20′ (e.g. LEDs) arranged in two groups. In each group two of the light sources 20′ are arranged in a back-to-back configuration, and may receive the same control signal. The light sources 20′ may also receive different control signals, for example (in FIG. 7) one signal derived from the top part and one signal derived from the bottom part of the image on the screen 10.

Alternatively, as shown in FIG. 8, a full loop can be constructed using an O-shaped light guide 31 surrounding the screen 10 and only 2 back-to-back light sources 20′.

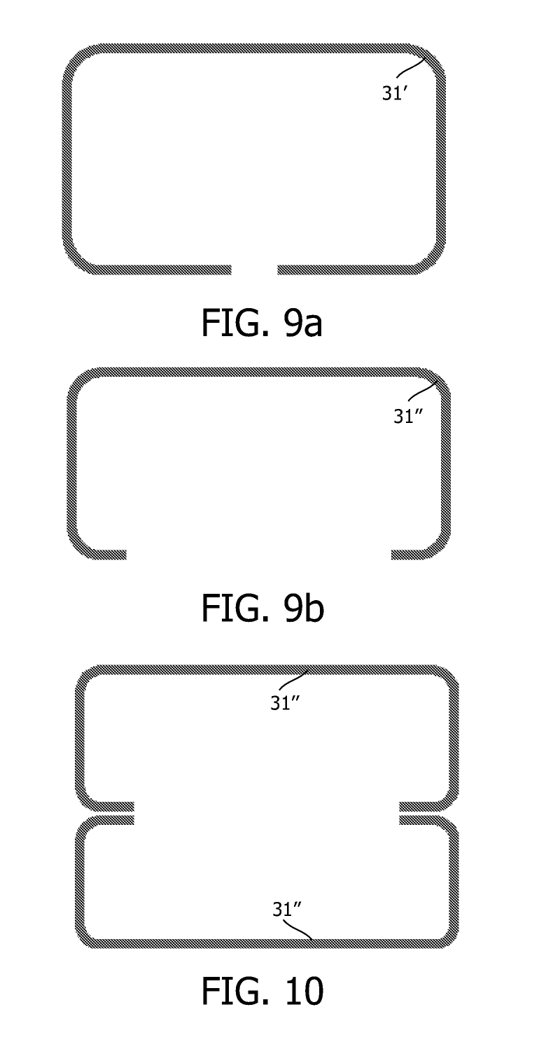

FIGS. 9a and 9b show two different shapes of light guides 31′, 31″ having an open O-shape and four curves. The opening of the open O-shape of the light guide 31′ shown on FIG. 9a is small, and for small screen sizes this light guide 31′ can be a good solution for full surround with only 2 LEDs (not shown). The light guide 31″ shown on FIG. 9b has a bigger opening of the open O-shape than the one on FIG. 9a. This light guide 31″ can be used alone in a lighting or illumination system, but it is also possible to use the pair configuration shown on FIG. 10 for a full surround solution. 2 (one on each side) or 4 (two on each side) LEDs (not shown) can be used in the full surround lighting or illumination system. The LEDs that are close to each other can have the same color, but different colors are also possible (e.g. multi-color LEDs).

It has found to be difficult to demonstrate AmbiLight in brightly illuminated environments where the effect is largely deteriorated, resulting in pale colors around the screen. Especially in shop environments this effect is of very undesirable. In such environments, a self illuminating surface appears to have a much better visibility than an illuminated surface like a canvas on which light is projected.

In view hereof, the U-shaped light guides can be arranged to illuminate the bezel of a display device. Bezel illumination creates an aura closer around the screen and it is more visible in environments with brighter illumination. It also makes AmbiLight possible for devices that are not in the proximity of a wall to reflect the light, like monitors. It has been found that people appreciate the light frame around the screen for more relaxed viewing experience while working with a PC and monitor. Monitors with bezel illumination are particularly suitable for game players who look for more immersion.

The invention can be summarized as follows: disclosed are further improvements of AmbiLight Displaying Arrangement, a lighting or illumination system that has been introduced to enhance viewing experience. The system can comprise one or two U-shaped light guides, the legs of which spatially correspond to three or four sides of the display screen/display device. In one possible embodiment, the light sources illuminate a background surface behind the display device or TV, such as a wall. In another possible embodiment, the light sources are arranged around the display screen/display device in substantially the same planar area, and radiate light to the front, either alone or in combination with background illumination. In yet another possible embodiment, at least one light source, being a pure light source (e.g. LED) and/or a light guide, is arranged to directly or/and indirectly illuminate the dark area between the pixel area of the display screen and the front of the lighting or illumination system, thus covering with illumination the area of the panel rim of the display device or arrangement.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practiced in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims, however the inclusion of the reference signs is only for clarity reasons and should not be construed as limiting the scope of the claims.

1. A display device comprising a display screen (10) for presenting video image(s) and a panel rim (70) surrounding the pixel area of the display screen (10), the display device further comprising at least one light source of a lighting or illumination system (20, 30, 50, 60) for producing an illumination and/or lighting effect to enhance viewing of the video image(s) on the display screen (10), wherein said at least one light source is further arranged to directly or/and indirectly illuminate the dark area (70) between the pixel area of the display screen (10) and the front of the lighting or illumination system (20, 30, 50, 60), thus covering with illumination the area of the panel rim (70).

2. The device according to claim 1, wherein said at least one light source is an U-shaped light guide (30, 30′, 30″) and the legs of said at least one light guide (30, 30′, 30″) are spatially corresponding to respective sides of the display screen (10).

3. The device according to claim 2, comprising a second U-shaped light guide (30′, 30″), wherein the two light guides (30′, 30″) are being arranged in such a configuration that together they form a closed shape surrounding the display screen (10).

4. The device according to claim 1, wherein said at least one light source is arranged to radiate light in substantially the same direction as the display screen (10).

5. The device according to claim 1, wherein said at least one light source is arranged to illuminate a surface behind the display screen (10).

6. The device according to claim 1, wherein said at least one light source cooperates with at least one of: a diffuser and a reflector of the lighting or illumination system (20, 30, 50, 60) in order to illuminate the dark area between the pixel area of the display screen (10) and the front of the lighting or illumination system (20, 30, 50, 60), thus covering with illumination the area of the panel rim (70).

7. A method for displaying video image(s) on a display device, comprising the step of:
displaying said video image(s) on a display screen (10) of the display device, and
producing an illumination and/or lighting effect with help of at least one light source of a lighting or illumination system (20, 30, 50, 60) in order to enhance viewing of the video image(s) on the display screen (10),
wherein said at least one light source further illuminates the dark area (70) between the pixel area of the display screen (10) and the front of the lighting or illumination system (20, 30, 50, 60), thus covering with illumination the area of a panel rim (70).

8. The method according to claim 7, wherein said at least one light source radiates light in substantially the same direction as the display screen (10).

9. The method according to claim 7, wherein said at least one light source illuminates a surface behind the display screen (10).

10. The method according to claim 7, wherein said at least one light source cooperates with at least one of: a diffuser (60) and a reflector (50) of the lighting or illumination system (20, 30, 50, 60) in order to illuminate the dark area (70) between the pixel area of the display screen (10) and the front of the lighting or illumination system (20, 30, 50, 60), thus covering with illumination the area of the panel rim (70).
